(19) United States
(12) Patent Application Publication
(10) Pub. No.: US 2026/0003950 A1
(43) Pub. Date: Jan. 1, 2026

(54) AUTHENTICATION METHOD

(71) Applicant: STMicroelectronics International N.V., Geneva (CH)

(72) Inventor: Michael PEETERS, Tourinnes-La-Grosse (BE)

(73) Assignee: STMicroelectronics International N.V., Geneva (CH)

(21) Appl. No.: 19/241,215

(22) Filed: Jun. 17, 2025

(30) Foreign Application Priority Data
Jun. 28, 2024 (FR) FR2407028

(51) Int. Cl. G06F 21/44

(52) U.S. Cl. CPC G06F 21/44; G06F 2221/2103

(57) ABSTRACT

The present description concerns a method of authenticating a first device to a second device, comprising the following successive steps: sending, by said second device, to said first device, of at least a first data item; use, by said first device, of a first neural network to deliver a second data item based on said at least one first data item; and sending, by said first device, of said second data item to said second device.

### CROSS-REFERENCE TO RELATED APPLICATION(S)

This application claims the priority benefit of French patent application number FR2407028, filed on Jun. 28, 2024, entitled “Procédé d'authentification,” which is hereby incorporated by reference to the maximum extent allowable by law.

### BACKGROUND

### Technical Field

The present disclosure generally concerns electronic circuits and devices, and more particularly the security of electronic circuits and devices. The present disclosure more specifically relates to the implementation of an authentication method enabling, for example, a plurality of electronic devices to start a reliable communication.

### Description of the Related Art

A communication between two electronic devices, or circuits, is often preceded by an authentication phase. During this phase, an authentication method, implemented by both devices, verifies whether the two devices are authorized to communicate with each other.

Authentication methods are often used during communications between a device of terminal type and electronic equipment or a device of peripheral type, for example a consumable or an accessory. The authentication method may enable, in this case, to validate the access by the peripheral-type device to the data and/or to functionalities of the terminal-type device. The authentication method is a first means of protection against malicious devices trying to access data and/or functionalities of other devices.

It would be desirable to be able to improve, at least partly, known authentication methods.

### BRIEF SUMMARY

There exists a need for increasingly secure authentication methods, allowing a more reliable authentication of an electronic circuit or device to another electronic circuit or device.

There exists a need for electronic circuits and devices implementing more secure authentication methods.

An embodiment overcomes all or part of the disadvantages of known authentication methods, and of circuits or devices implementing such methods.

An embodiment provides the use of neural networks for the implementation of an authentication method.

An embodiment provides circuits and devices adapted to implementing neural networks to execute such authentication methods.

An embodiment provides neural network training methods adapted to implementing such authentication methods.

An embodiment provides, in particular, the use of neural networks enabling to recognize the presence of a feature in a data item.

Another embodiment provides, in particular, the use of neural networks enabling to classify a data item in one of a plurality of categories.

Another embodiment provides, in particular, the use of neural networks enabling to extract a hidden data item from another data item.

Another example provides, in particular, the use of neural networks enabling to generate random data.

An embodiment provides a method of authenticating a first device to a second device, comprising the following successive steps:
Sending, by said second device, to said first device, of at least one first data item;
Using, by said first device, of a first neural network to supply a second data item based on said at least one first data item;
Sending, by said first device, of said second data to said second device.

Another embodiment provides an electronic device being adapted to being the first electronic device in the method of authentication of the first device to a second device, comprising the following successive steps:
Sending, by said second device, to said first device, of at least one first data item;
Using, by said first device, of a first neural network to supply a second data item based on said at least one first data item;
Sending, by said first device, of said second data to said second device.

Another embodiment provides an electronic device being adapted to being the second electronic device in the method of authenticating a first device to the second device, comprising the following successive steps:
Sending, by said second device, to said first device, of at least one first data item;
Use, by said first device, of a first neural network to supply a second data item based on said at least one first data item;
Sending, by said first device, of said second data item to said second device.

According to an embodiment, said first neural network is adapted to recognizing the presence of a feature in said at least one first data item, and said second data item is a binary data item indicating whether said feature is recognized or not.

According to an embodiment, said at least one first data item is selected by a first group comprising third data preprocessed by said first neural network.

According to an embodiment, said at least one first data item is selected by a second group comprising fourth data preprocessed by said first neural network, said second group satisfying the following mathematical formula:

$$dist ( V 0 , {V}^{′} 0 ) ≅ dist ( V 1 , {V}^{′} 1 ) ≅ dist ( V 0 , V 1 ) \qquad Math 1$$

where:
V0 and V′0 are preprocessed data leading to the first value of the output data item;
V1 and V′1 are preprocessed data leading to the second value of the output data item;
dist is a function enabling to calculate a distance in a multi-dimensional space comprising data V0, V′0, V1, and V′1; and
≅ is a symbol representing a relative equality of the type “in the order of”.

According to an embodiment, said first neural network is adapted to classifying said at least one first data item according to at least three categories, and said second data item indicating which category said at least one first data item belongs to.

According to an embodiment, said second data item has been hidden in said at least one first data item, and
said first neural network is adapted to extracting the second data item from said at least one first data item.

According to an embodiment, said second data item has been hidden in said at least one first data item by using at least a steganography technique implemented by a second neural network.

According to an embodiment, said first neural network is adapted to randomly generating said second data item based on at least two first data items comprising a fifth generation data item and at least one sixth context data item.

According to one embodiment, said first device sends, in addition to said second data item, at least one seventh context data item different from said sixth context data item,
said second device being adapted to randomly generating an eighth data item by using said fifth generation data item and said at least one seventh context data item,
said second device using the second data item and the eighth data item to verify whether the first device is authenticated or not to the second device.

According to an embodiment, the method further comprises a step of verification of said second data item by said second device enabling to indicate whether the first device is authenticated or not to the second device.

According to an embodiment, the method further comprises a step of verification of the number of times a specific first data item is supplied to the first device.

According to an embodiment, the method further comprises a step of verification of the response time of the first device, implemented by said second device.

According to an embodiment, the method further comprises a step of encryption of the second data item before its sending to the second device.

Another embodiment provides a method of training a neural network of a first device for the implementation of a previously-described authentication method.

Another embodiment provides a system comprising a previously-described device and a previously-described device.

Another embodiment provides a computer program product comprising program code instructions for the execution of the steps of the method previously described as being said first device, when said program is run on a computer.

Another embodiment provides a computer program product comprising program code instructions for the execution of the steps of the method previously described as being said second device, when said program is run on a computer.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an example of an electronic device adapted to implementing the authentication method implementation modes described in relation with FIGS. 2 to 17 in some embodiments;

FIG. 2 shows a block diagram illustrating an implementation mode of a method of authenticating a first device to a second device in some embodiments;

FIG. 3 shows a block diagram illustrating an implementation mode of a method of preparing the authentication method of FIG. 2 in some embodiments;

FIG. 4 shows a block diagram illustrating another implementation mode of a method of authenticating a first device to a second device in some embodiments;

FIG. 5 shows a block diagram illustrating an implementation mode of a method of preparing the authentication method of FIG. 4 in some embodiments;

FIG. 6 shows, schematically, the implementation of a neural network in some embodiments;

FIG. 7 shows a block diagram illustrating another method of implementing a method of authenticating a first device to a second device in some embodiments;

FIG. 8 shows a block diagram illustrating an implementation mode of a method of preparing the authentication method of FIG. 7 in some embodiments;

FIG. 9 shows a block diagram illustrating another implementation mode of a method of authenticating a first device to a second device in some embodiments;

FIG. 10 shows a block diagram illustrating the implementation of a steganography technique in some embodiments;

FIG. 11 shows a block diagram illustrating another implementation mode of a method of preparing the authentication method of FIG. 9 in some embodiments;

FIG. 12 shows a block diagram illustrating another implementation mode of a method of preparing the authentication method of FIG. 9 in some embodiments;

FIG. 13 shows a block diagram illustrating another implementation mode of a method of authenticating a first device to a second device in some embodiments;

FIG. 14 shows a block diagram illustrating an implementation mode of a method of preparing the authentication method of FIG. 13 in some embodiments;

FIG. 15 shows a block diagram illustrating the generation of random numbers using two neural networks in some embodiments;

FIG. 16 shows a block diagram illustrating another implementation mode of a method of authenticating a first device to a second device in some embodiments;

FIG. 17 shows a block diagram illustrating an implementation mode of a method of preparing the authentication method of FIG. 15 in some embodiments.

### DESCRIPTION OF EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front,” “back,” “top,” “bottom,” “left,” “right,” etc., or relative position qualifiers, such as “top,” “bottom,” “upper,” “lower,” etc., or orientation qualifiers, such as “horizontal,” “vertical,” etc., reference is made unless otherwise specified to the orientation of the drawings.

Unless specified otherwise, the expressions “about,” “approximately,” “substantially,” and “in the order of” signify plus or minus 10%, preferably of plus or minus 5%. The embodiments described hereafter concern the implementation of an

authentication method enabling to authenticate a first electronic device to a second electronic device, for example, with a view to future communication between these first and second devices. These embodiments are more particularly authentication methods of verifier/prover type, also known as verifier/candidate type, in which a verifier device, here the second device, sends a data item to the prover device, here the first device, so that it applies a transformation thereto. The prover device then returns the result of said transformation to the verifier device so that it verifies it. If the result of the verification is correct, then the prover device is authenticated to the verifier device.

There is called authentication system an electronic system comprising a verifier device and a prover device.

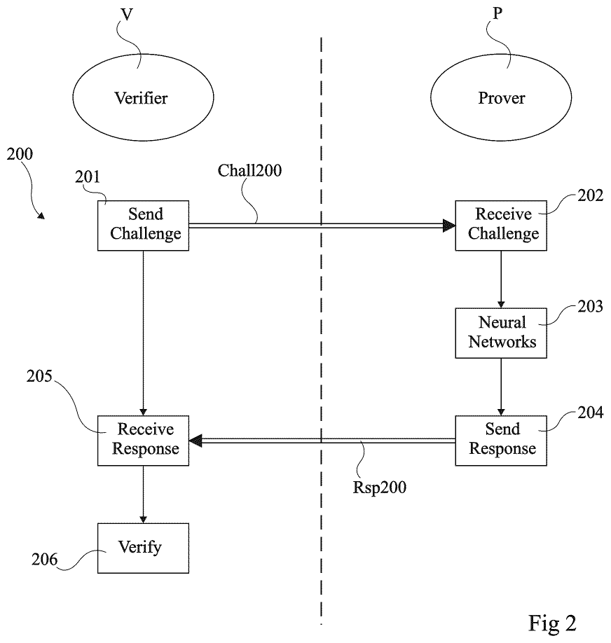

The embodiments described hereafter more particularly concern the implementation of an authentication method by using at least one neural network. More specifically, it is aimed at an authentication method of verifier/prover type in which the prover device uses a neural network to supply the result data item intended for the verifier device. For this purpose, the prover device may use any type of neural network. Four specific types of neural networks are described hereafter. A first type is a neural network trained to verify whether a specific feature is present in a data item or not. A second type is a neural network trained to classify a data item according to a plurality of categories. A third type is a neural network trained to extract a hidden data item from another data item. A fourth type is a neural network trained to generate random or pseudo-random data. These embodiments are described in detail in relation with FIGS. 2 to 17.

Further, the above-described embodiments are particularly adapted to being used in any type of industrial markets where an authentication between two electronic devices is required. More particularly, such an authentication method may be intended for applications including, but not limited to:
the automotive industry, for example in the field of automotive electrification or in the field of advanced driver assistance systems (ADAS);
the industrial sector, for example in the field of green energy, in the field of infrastructure electrification, of the Internet of Things (IoT) and of smart homes, where electricity and energy consumption and data exchange are key elements;
the personal electronics industry, for example in the field of mobile telephony and of the Internet of Things (IoT), as well as in the field of high speed interfaces; and
the industry of communications equipment, computers, and peripherals, for example in the field of infrastructures and data centers, and in the field of low earth orbit (LEO) satellites.

Further, the embodiments described hereafter are particularly adapted to any type of system in which two electronic devices require reliably communicating with each other. Such a system may be, for example, a system comprising a terminal device and a portable-type device, or a system comprising a terminal device and a consumable-type device. Another example is a system comprising two electronic devices formed on a same chip and having to reliably communicate.

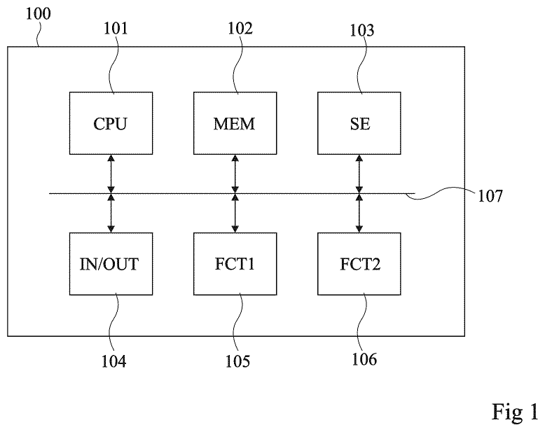

FIG. 1 is a block diagram schematically showing an architecture of an example of an electronic device 100 adapted to implementing an authentication method according to an embodiment. Device 100 may indifferently be a verifier device and/or a prover device of said authentication method. Device 100 may even form an authentication system on its own, comprising the verifier device and the prover device.

In some embodiments, electronic device 100 comprises a processor 101 (CPU) adapted to implementing different processings of data stored in memories and/or supplied by other circuits of device 100. According to an embodiment, processor 101 is adapted to implementing an authentication method, and/or one or a plurality of neural networks.

In some embodiments, electronic device 100 further comprises different types of memories 102 (MEM), including, for example, a non-volatile memory, a volatile memory, and/or a read-only memory. Each memory 102 may be adapted to storing different types of data.

In some embodiments, electronic device 100 further comprises a secure element 103 (SE) adapted to processing sensitive and/or secret data. Secure element 103 may comprise its own processor(s), its own memory or memories, etc. According to an embodiment, secure element 101 is adapted to implementing an authentication method, and/or one or a plurality of neural networks.

In some embodiments, electronic device 100 may further comprise interface circuits 104 (IN/OUT) adapted to sending and/or to receiving data from the outside of device 100. Interface circuits 104 may further be adapted to implementing a data display, for example, a display screen. According to an embodiment, interface circuits 104 are adapted to implementing an authentication method, and/or one or a plurality of neural networks.

In some embodiments, electronic device 100 further comprises different circuits 105 (FCT1) and 106 (FCT2) adapted to implementing different functions. As an example, circuits 105 and 106 may comprise measurement circuits, data conversion circuits, etc. According to an embodiment, circuits 105 and 106 may comprise one or a plurality of circuits adapted to implementing an authentication method and/or one or a plurality of neural networks. According to a specific embodiment, circuits 105 may comprise measurement circuits, analog-to-digital converters, calculation circuits, etc.

In some embodiments, electronic device 100 further comprises one or a plurality of data buses 107 adapted to transferring data between its different components.

In some embodiments, an authentication system comprising two devices of the type of device 100 may be adapted to implementing one of the authentication methods according to an embodiment described hereafter.

In some embodiments, electronic device 100 may be a complex electronic device, such as a computer, comprising program code means or instructions allowing the implementation of the authentication method implementation modes described hereafter, when said program is run on a computer.

FIG. 2 is a block diagram illustrating an implementation mode of an authentication method 200 enabling to authenticate a first electronic device P, also called prover device P, to a second electronic device V, also called verifier device V. In other words, authentication method 200 is adapted to being implemented by an authentication system comprising devices P and V. According to an embodiment, devices P and V are of the type of the device 100 described in relation with FIG. 1.

As previously described, authentication method 200 is a method of verifier/prover type.

At an initial step 201 (Send Challenge), authentication method 200 begins, for which purpose verifier device V selects a data item Chall200, also known as challenge data item Chall200, to send it to prover device P.

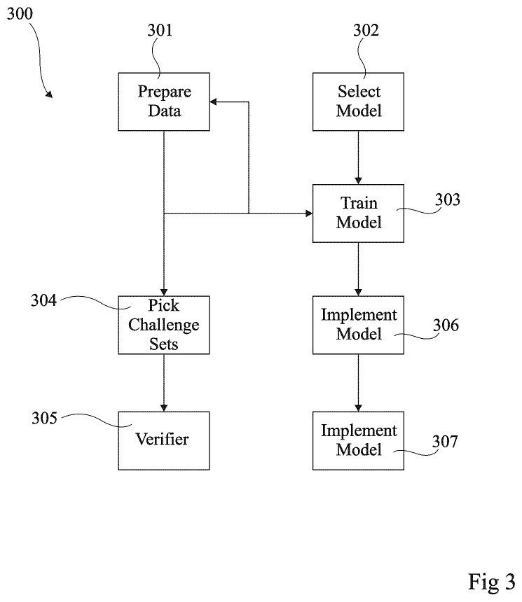

According to an embodiment, data item Chall200 is selected from a finite group of data enabling to implement authentication method 200. The set of data from which data item Chall200 is selected is defined in further detail in relation with FIG. 3.

In some embodiments, device V may use a secure communication channel to send data item Chall200 to device P.

At a step 202 (Receive Challenge), successive to step 201, prover device P receives data item Chall200 and may begin to implement the authentication method for its part.

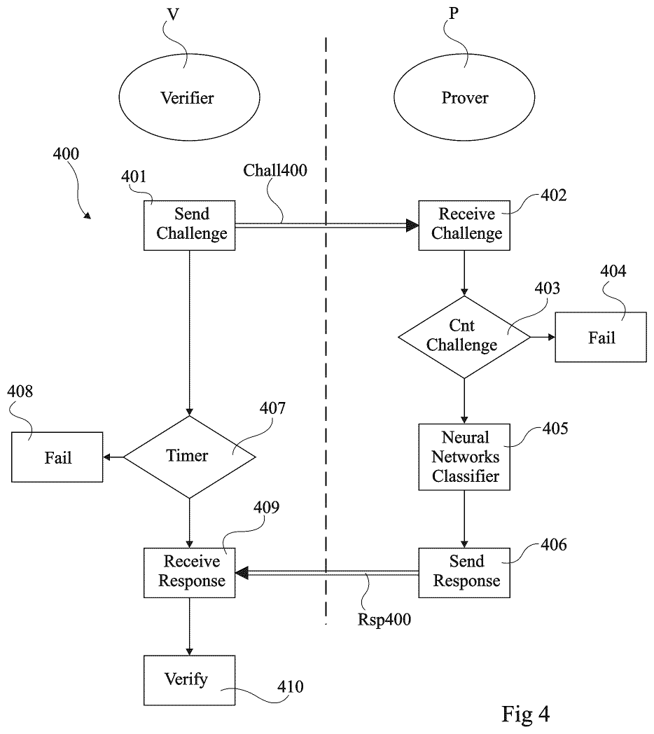

In some embodiments, at step 202, device P may implement one or a plurality of steps of verification of data item Chall200. In some embodiments, device P may verify the number of times that it has already received a specific value of data item Chall200, and refuse to implement the authentication method if it has received the specific value too many times. According to another example, device P may verify the format of data item Chall200. An example of such a verification step is described in further detail in relation with FIG. 4.

At a step 203 (Neural Networks), successive to step 202, prover device P uses a neural network to provide, or to generate, a response data item Rsp200 based on data item Chall200. Specific examples of a mode of different neural networks capable of being used here are described hereafter. Response data item Rsp may take different forms, according to the use of the neural network.

At a step 204 (Send Response), device P sends response data item Rsp200 to device V.

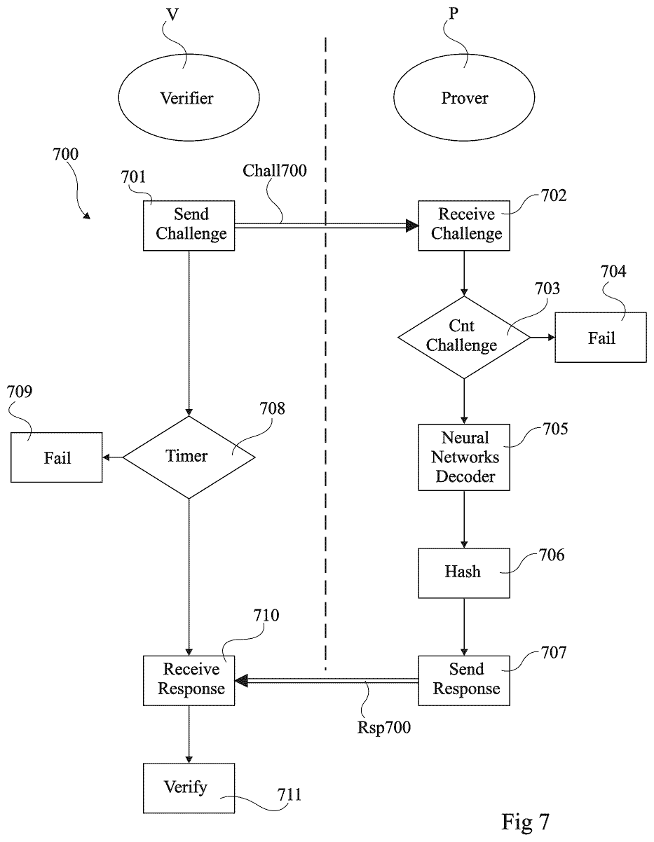

In some embodiments, at step 202, device P may implement one or a plurality of steps of encryption of data item Rsp200 before its sending to device V. In some embodiments, device P may send a signature of data item Rsp200 to device V. An example of such an encryption step is described in further detail in relation with FIG. 7.

In some embodiments, device P may use a secure communication channel to send response data item Rsp200 to device V.

At a step 205 (Receive Response), successive to step 204, verifier device V receives the response data item from prover device P.

In some embodiments, verifier device V may implement one or a plurality of verification steps and one or a plurality of steps of decryption of response data item Rsp200.

In some embodiments, verifier device V may further verify the response time of prover device P. Such a step is described in further detail in relation with FIG. 4.

At a step 206 (Verify), verifier device V uses response data item Rsp200 to conclude as to the authentication, or not, of prover device P. According to an embodiment, device V may use a mathematical verification function, for example a comparison function, or a mathematical verification function implemented by a neural network.

FIG. 3 is a block diagram illustrating an implementation mode of a method 300 of preparing the authentication method 200 described in relation with FIG. 2.

Generally, method 300 comprises a method of training the neural network used by device P, and a method of generating a data group from which data item Chall200 is selected. Method 300 further comprises the preparation of devices V and P.

At an initial step 301 (Prepare Data), a group of data adapted to being used as training data for the neural network of device P is generated. In some embodiments, this data group may be an already-existing data group or a data group generated with a view to authentication method 200.

At another initial step 302 (Select Model), a neural network model is selected from the different existing neural networks models. This step may further comprise a calculation of the adaptive parameters, also referred to as weights, defining the neural network.

At a step 303 (Train Model), successive to steps 301 and/or 302, the neural network model defined at step 302 is trained by using the data of the group of data generated at step 301. In some embodiments, the data group of step 301 may be consolidated as a result of this training.

At a step 304 (Pick Challenge Sets), data are selected to form a set of data used to implement authentication method 200. For this purpose, data may be generated in the same way as the data of step 301, and/or data may be selected from the group generated at step 301, and, if necessary, consolidated at step 303. According to an embodiment, the data group formed at step 304 comprises fewer data items, or in rare cases the same number of data items, as the data group generated at step 301.

According to a variant, the data set is formed by applying one or a plurality of operations to data of the data group of step 301.

At a step 305 (Verify), the data set defined at step 304 is loaded, stored, in device V so that it can be used to implement authentication method 200.

At a step 306 (Implement Model), the neural network has been trained and can be implemented in an electronic circuit or device.

At a step 307 (Prover), prover device P is equipped with the circuit or device in which said neural network is implanted.

Thus, a method of training the neural network of the device P of FIG. 2 comprises the following steps:
a training group of data capable of being used for authentication method 200 is generated;
a neural network model is selected;
said neural network model is trained by using the data of said group of data; and
optionally, said data group is consolidated during the implementation of the model training.

FIG. 4 is a block diagram illustrating a first example of an implementation mode of an authentication method 400 for authenticating prover device P to verifier device V, both defined in relation with FIG. 2.

Authentication method 400 is a method of verifier/prover type of the type of the authentication method 200 described in relation with FIG. 2. The elements common to methods 200 and 400 are not described again in detail herein. Only the differences between these methods are highlighted.

As previously mentioned, authentication method 200 uses a neural network, implemented by prover device P. In authentication method 400, this neural network is adapted to recognizing the presence, or absence, of a feature in a data item, and to providing a data item indicating this presence or absence. For example, if the data item is an image, the feature could be the presence or absence of a specific object such as an animal in this image. Such a neural network may also be called a classifier.

At an initial step 401 (Send Challenge), authentication method 400 begins, for which purpose verifier device V selects a data item Chall400 to send it to prover device P.

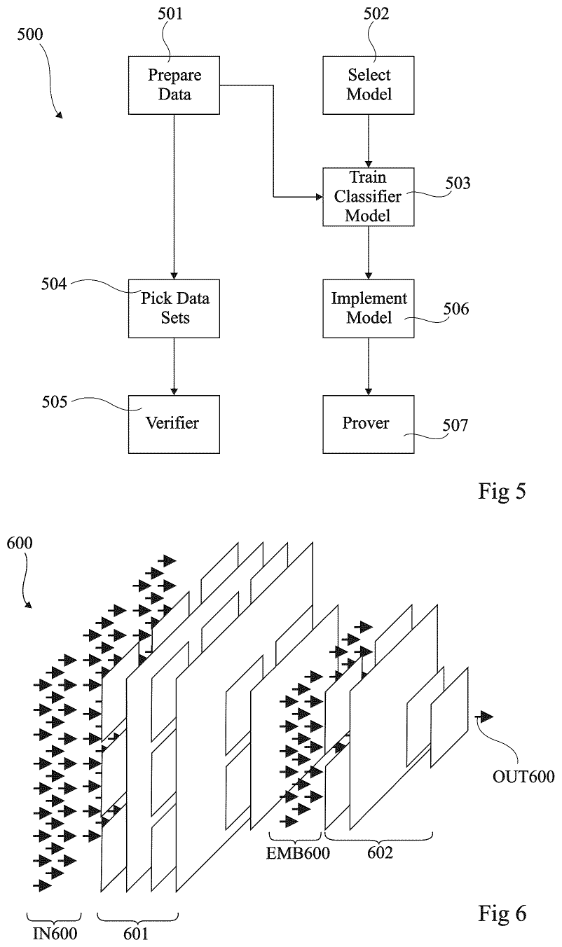

According to an embodiment, data item Chall400 is selected from a finite group of data enabling to implement authentication method 400. Examples of groups of data from which data item Chall400 is selected are defined in further detail in relation with FIGS. 5 and 6.

Further, each data item Chall400 in the data group is associated a response data item Chall400Rsp representing the value that device P must supply device V with to be authenticated.

At a step 402 (Receive Challenge), successive to step 401, prover device P receives data item Chall400 and may begin to implement the authentication method on its own.

At a step 403 (Cnt Challenge), device P may verify whether data item Chall400 has not already been sent to it too many times. More particularly, in the context of the implementation of method 400, for each data value received from another device, device P increments a counter. When the value of this counter reaches a limiting value, a subsequent step is a step 404 (Fail) where device P considers that method 400 has failed. In some embodiments, at step 404, device P may send a data item indicating the abortion of authentication method 400 to device V.

If the counter value does not exceed the limiting value, the next step is a step 405 (Neural Networks Classifier).

At step 405, successive to step 403, prover device P uses a neural network to supply, or to generate, a response data item Rsp400 based on data item Chall400. in some embodiments, response data item Rsp400 is a binary data item representing a bit indicating the presence or absence of a feature in data item Chall400. Thus, according to an embodiment, response data item Rsp400 may take two values only, a first value indicating the presence of the feature, and a second value indicating the absence of this feature.

At a step 406 (Send Response), device P sends response data item Rsp400 to device V.

At a step 407 (Timer) implemented at the end of step 401, device V verifies the response time of device P. For this purpose, as soon as data item Chall400 is sent, device V starts a timer that it stops either when it receives data item Rsp400 or when the timer value has reached a limiting value. When the value of this timer reaches a limiting value, a subsequent step is a step 408 (Fail) where device V considers that method 400 has failed.

If device V receives data item Rsp400 before the timer reaches the limiting value, the next step is a step 409 (Receive Response).

At step 409, successive to step 404, verifier device V receives the response data item from prover device P.

At a step 410 (Verify), verifier device V uses response data item Rsp400 to conclude as to the authentication, or not, of prover device P. For this purpose, device V may, for example, compare response data item Rsp400 with response data item Chall400Rsp. According to another example, at this step, device V implements a verification function taking as an input data item Rsp400, data item Chall400, and/or Chall400Rsp.

An advantage of this embodiment is that it enables use of neural networks already known in literature.

FIG. 5 is a block diagram illustrating an implementation mode of a method 500 of preparing the authentication method 400 described in relation with FIG. 4.

Generally, method 500 comprises a method of training the neural network used by device P, and a method of generating a data group from which data item Chall400 is selected. Method 500 further comprises the preparation of devices V and P.

At an initial step 501 (Prepare Data), a group of data adapted to being used as training data for the neural network of device P is generated. In some embodiments, this data group may be an already-existing data group or a data group generated with a view to authentication method 400.

At another initial step 502 (Select Model), a neural network model allowing the detection of a feature of a data item is selected from the different existing neural network models. This step may further comprise a calculation of the adaptive parameters, also referred to as weights, defining the neural network.

At a step 503 (Train Model), successive to steps 501 and/or 502, the neural network model defined at step 502 is trained by using the data from the data group generated at step 501. In some embodiments, the data group of step 501 may be consolidated as a result of this training, this example is detailed in relation with FIG. 6.

At a step 504 (Pick Challenge Sets), data are selected to form a set of data used to implement authentication method 400. For this purpose, data may be generated in the same way as the data of step 501, and/or data may be selected from the group generated at step 501, and, if necessary, consolidated at step 503. According to an embodiment, the data group formed at step 504 comprises fewer data items, or in rare cases the same number of data items, as the data group generated at step 501.

At a step 505 (Verify), the data set defined at step 504 is loaded, stored, in device V so that it can use it to implement authentication method 400.

At step 506 (Implement Model), the neural network has been trained and can be implemented in an electronic circuit or device.

At a step 507 (Prover), prover device P is equipped with the circuit or device in which said neural network is implanted.

Thus, a method of training the neural network of the device P of FIG. 4 in some embodiments comprises the following steps:
a group of training data adapted to being used in authentication method 400 is generated;
a neural network model is selected;
said neural network model is trained by using the data of said data group; and
optionally, said data group is consolidated during the implementation of the model training.

FIG. 6 shows, schematically, the implementation of a neural network 600 of the type of the neural network used by device P in the method 400 described in relation with FIG. 1 in some embodiments.

Neural network 600 is adapted to receiving an input data item IN600 and to supplying an output data item OUT600.

Input data item IN600 is a raw data item which may comprise a plurality of parameters and/or sub-data. In some embodiments, input data item IN600 may be a data item comprising a plurality of data bits, a set of binary data, a data vector, an image comprising a plurality of pixels, etc.

Output data item OUT600 is a data item representing a data bit, that is, a data item having a value that can only take two values, such as a TRUE value and a FALSE value. This here is the case because neural network 600 is used to verify the presence, or not, of a feature in input data item IN600. Thus, a first value that can be taken by output data item OUT600 indicates the presence of said feature, and a second value that can be taken by output data item OUT600 indicates the absence of said feature.

To deliver output data item OUT600, neural network 600 submits input data item IN600 to a plurality of processing operations. More particularly, neural network 600 comprises a first set of processing operations 601, also called pre-processes 601, enabling to prepare input data item IN600, and a second set of processing operations 602 enabling to supply output data item OUT600.

The first set of processing operations 601 enables to deliver a preprocessed data item EMB600 to the second set of processing operations 602. Preprocessed data item EMB600 is also referred to as embedding. In some embodiments, the processing operations of set 601 enable to adapt the format of input data item IN600, to decrease the noise present in input data item IN600, to highlight the significant elements of input data item IN600, etc. In other words, the processing operations of set 601 enables to provide set 602 with a preprocessed data item EMB600, which is normalized and adapted to being used as is by neural network 600 to make a decision. Such a preprocessed data item EMB6000 is also referred to as “embeddings,” which is defined in literature as a “continuous” encoding of small dimension, it is for example a vector of real numbers, representative of a discrete data item, most often obtained during a training phase. An embedding, which may also be a set of continuous data, is better adapted to manipulation and processing by neural networks.

The second set of processing operations 602 enables, based on data item EMB600, to supply result data item OUT600. In other words, the processing operations of set 602 are the layers of neural network 600 adapted to effectively recognizing the presence, or not, of the feature in question in the data item sent as an input. However, the processing operations of set 602 cannot be directly applied to a raw data item, hence the need for the set of processing operations 601.

During a training phase of neural network 600, it is possible to generate a large quantity of preprocessed data of the type of data item EMB600. It is sufficient for this purpose to present a large number of raw data items to neural network 600. It is previously indicated that it is possible to consolidate a group of data used to train a neural network, adding preprocessed data is an example of consolidation of this group.

According to a first embodiment, at step 504, described in relation with FIG. 5, of selection of the data used for the implementation of the authentication method 400 described in relation with FIG. 4, it is possible to create a group only formed of preprocessed data to be loaded into device V. This may have several advantages. A first advantage is that a preprocessed data item is no longer a data item that can be easily read by a spy device, and can thus make the observation of method 400 more difficult. A second advantage is that it may enable the use of a truncated version of a neural network, that is, a neural network comprising only one set of processing operations of the type of set 602. A third advantage is that, generally, a preprocessed data item of embedding type is of smaller size than a discrete data item, to be supplied to a neural network. Using such a neural network can also make the use of spy devices more difficult.

In a second embodiment, still at step 504, it is possible to create a group only formed of preprocessed data to be loaded into device V, and it is also possible to generate a group of preprocessed data, the analysis of which by assembly 602 is more difficult. For this purpose, it is sufficient to create a very similar group formed of preprocessed data, but leading to different output data. Mathematically, such a group can be defined as a set comprising preprocessed data leading to the first value of the output data item and preprocessed data leading to the second value of the output data item, and satisfying the following mathematical formula:

$$dist ( V 0 , {V}^{′} 0 ) ≅ dist ( V 1 , {V}^{′} 1 ) ≅ dist ( V 0 , V 1 ) \qquad Math 2$$

where:
V0 and V′0 are preprocessed data leading to the first value of the output data item;
V1 and V′1 are preprocessed data leading to the second value of the output data item;
dist is a function enabling to calculate a distance in a multi-dimensional space comprising data V0, V′0, V1, and V′1; and
≅ is a symbol representing a relative equality of the type “in the order of”.

In some embodiments, a method of generating two data items of such a data group includes the following:
generating at least one data item D0 leading to the first value of the output data item;
generating at least one data item D1 leading to the second value of the output data item;
generating at least one data item D2 by averaging the first and second data items D0and D1, by using, for example, the previously-described function dist;
determining whether data item D2 leads to the first value of the output data item or to the second value of the output data item;
if data item D2 leads to the first value of the output data item, replacing the value of data item D0 with the value of data item D2, otherwise replacing the value of data item D1 with the value of data item D2;
repeating the last three steps until the distance between data items D0 and D1 is shorter than a limiting distance, considered as negligible, whereby data items D0 and D1 can be used as a data item for authentication method 400.

This second implementation mode has all the advantages of the first implementation mode described hereabove, but further has the advantage of making the creation of a clone more difficult, for example for an adversary who would try to duplicate the classification function performed by the neural network by observing only the content of the data selected at the step 504 described in relation with FIG. 5 to form the data set used to implement authentication method 400.

FIG. 7 is a block diagram illustrating a second example of an implementation mode of an authentication method 700 enabling to authenticate prover device P to verifier device V, both defined in relation with FIG. 2.

Authentication method 700 is a method of verifier/prover type of the type of the authentication method 200 described in relation with FIG. 2. The elements common to methods 200 and 700 are not described again in detail herein. Only the differences between these methods are highlighted.

As previously mentioned, authentication method 200 uses a neural network, implemented by prover device P. In authentication method 700, this neural network is adapted to classifying a data item according to a plurality of categories, preferably at least three categories. According to an example, if the data item is an image, the categories could be the presence of different specific objects, or of different animals on this image. Such a neural network may also be referred to as a classifier.

At an initial step 701 (Send Challenge), authentication method 700 begins, for which purpose verifier device V selects a data item Chall700 to send it to prover device P.

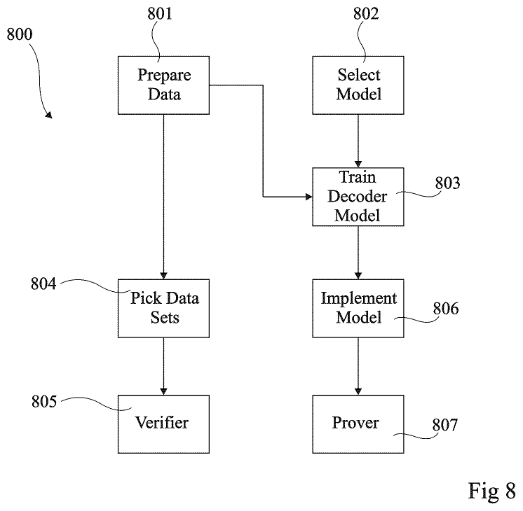

According to an embodiment, data item Chall700 is selected from a finite group of data enabling to implement authentication method 700. The set of data from which data item Chall700 is selected is defined in further detail in relation with FIG. 8.

Further, to each data item Chall700 in the data group is associated a response data item Chall700Rsp representing the value that device P has to supply device V with to be authenticated.

At a step 702 (Receive Challenge), successive to step 701, prover device P receives data item Chall700 and can begin to implement the authentication method for its part.

At a step 703 (Cnt Challenge), device P may verify whether data item Chall700 has not already been sent too many times thereto, by using a counter. This step is similar to the step 403 described in relation with FIG. 4. When the value of this counter reaches a limiting value, a next step is a step 704 (Fail) where device P considers that method 700 has failed. If the value of the counter does not exceed the limiting value, the next step is a step 705 (Neural Networks Decoder).

At step 705, successive to step 703, prover device P uses a neural network to deliver, or to generate, a response data item Rsp700 based on data item Chall700. Response data item Rsp700 indicates which category data item Chall700 belongs to. Thus, response data item Rsp700 is a binary data item capable of taking at least three different values, each value indicating a category. For example, if data item Chall700 is an image of an animal, response data item Rsp700 may represent different kinds of animals.

At an optional step 706 (Hash), device P may encrypt response data item Rsp700, for example by using an encryption algorithm, a signature algorithm, a hash algorithm, etc.

At a step 707 (Send Response), device P sends response data item Rsp700 to device V, or, if applicable, the encrypted version of response data item Rsp700.

At a step 708 (Timer) implemented at the end of step 701, device V verifies the response time of device P by using a timer. Step 708 is similar to the step 407 described in relation with FIG. 4. When the timer value reaches a limiting value, a next step is a step 709 (Fail) where device V considers that method 700 has failed. If device V receives data item Rsp700 before the timer reaches the limiting value, the next step is a step 710 (Receive Response).

At step 710, successive to step 704, verifier device V receives the response data item from prover device P. If data item Rsp700 has been encrypted, a decryption step may here be implemented.

At a step 711 (Verify), verifier device V uses the response data item Rsp700 to conclude as to the authentication or not of prover device P. For this purpose, device V may, for example, compare response data item Rsp700 with response data item Chall700Rsp. According to another example, at this step, device V implements a verification function taking as input data item Rsp700, data item Chall700, and/or Chall700Rsp.

An advantage of this embodiment is that it enables to increase the uncertainty of the response data item provided by prover device P with respect to the challenge. This thus makes authentication method 700 more difficult to circumvent.

FIG. 8 is a block diagram illustrating an implementation mode of a method 800 of preparing the authentication method 700 described in relation with FIG. 7.

Generally speaking, method 800 comprises a method of training the neural network used by device P, and a method of generating a data group from which data item Chall700 is selected. Method 800 further comprises the preparation of devices V and P.

At an initial step 801 (Prepare Data), a group of data adapted to being used as training data for the neural network of device P is generated. In some embodiments, this data group may be an already-existing data group or a data group generated with a view to authentication method 700.

At another initial step 802 (Select Model), a neural network model enabling to detect a feature of a data item is selected from the different existing neural network models. This step may further comprise a calculation of the adaptive parameters, also referred to as weights, defining the neural network.

At a step 803 (Train Model), successive to steps 801 and/or 802, the neural network model defined at step 802 is trained by using the data of the data group generated at step 801. In some embodiments, the data group of step 801 may be consolidated as a result of this training.

At a step 804 (Pick Challenge Sets), data are selected to form a set of data used to implement authentication method 200. For this purpose, data may be generated in the same way as the data of step 801, and/or data may be selected from the group generated at step 801, and, if necessary, consolidated at step 803. According to an embodiment, the data group formed at step 804 comprises fewer data items, or in rare cases the same number of data items, as the data group generated at step 801.

According to an alternative embodiment, the data selected at step 804 may be preprocessed data of the same type as the data EMB600 described in relation with FIG. 6. The neural network used is then of the same type as that described in relation with FIGS. 4 to 6.

At a step 805 (Verify), the data set defined at step 804 is loaded, or stored, in device V so that it can use it to implement authentication method 700.

At a step 806 (Implement Model), the neural network has been trained and can then be implanted in an electronic circuit or device.

At a step 807 (Prover), prover device P is equipped with the circuit or device in which said neural network is implanted.

Thus, in some embodiments a method of training the neural network of the device P of FIG. 7 comprises the following steps:
a group of training data capable of being used for authentication method 700 is generated;
a neural network model is selected;
said neural network model is trained by using the data of said data group; and
optionally, said data group is consolidated during the implementation of the model training.

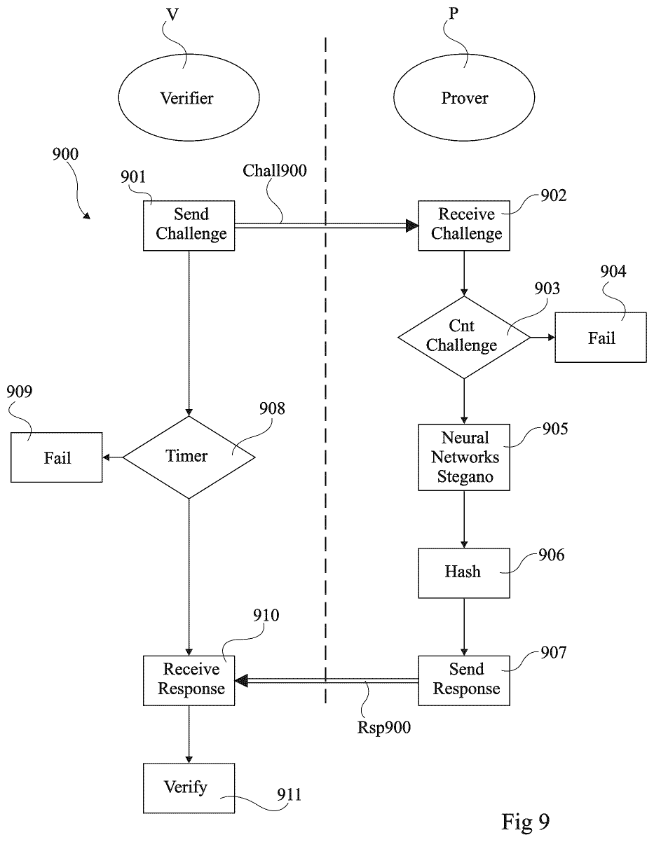

FIG. 9 is a block diagram illustrating a third example of an implementation mode of an authentication method 900 enabling to authenticate prover device P to verifier device V, both defined in relation with FIG. 2.

Authentication method 900 is a method of verifier/prover type of the type of the authentication method 200 described in relation with FIG. 2. The elements common to processing operations 200 and 900 are not described again in detail herein. Only the differences between these methods are highlighted.

As previously mentioned, authentication method 200 uses a neural network, implemented by prover device P. In authentication method 900, this neural network is adapted to extracting a hidden secret data item from another data item. In some embodiments, the secret data item is a binary word and the other data item is an image. More particularly, the secret data item may be hidden in the other data item by using steganography techniques.

At an initial step 901 (Send Challenge), authentication method 900 begins, for which purpose verifier V selects a data item Chall900 to send it to prover device P.

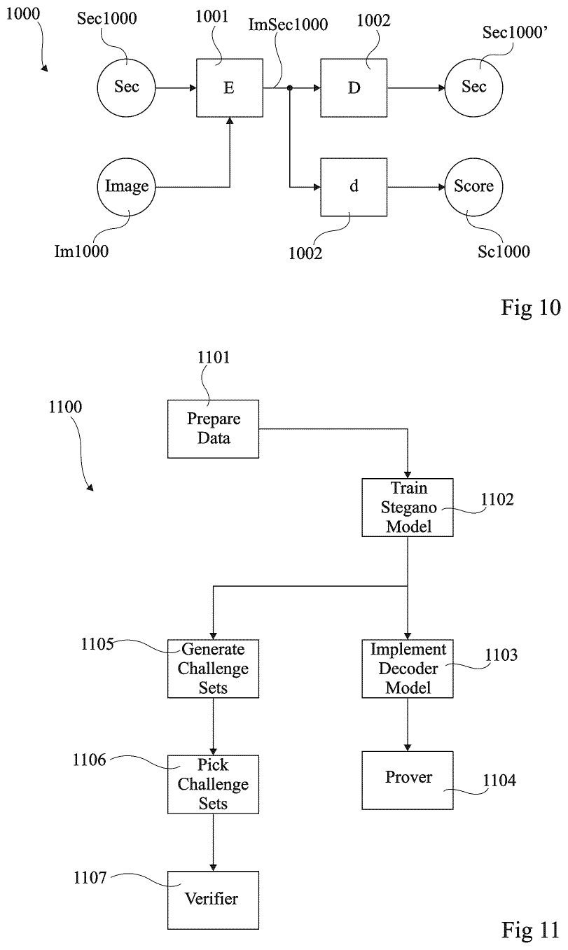

According to an embodiment, data item Chall900 is selected from a finite group of data enabling to implement authentication method 900. The set of data from which data item Chal1900 is selected is defined in further detail in relation with FIG. 10.

Further, each data item Chall900 in the data group is associated a response data item Chall900Rsp representing, for example, the value that device P has to supply to device V to be authenticated.

According to an embodiment, data item Chall900 here is a data item in which a secret data item, corresponding, for example, to response data item Chall900Rsp, is hidden. According to a specific example, data item Chall900 is an image in which response data item Chall900Rsp has been hidden by using steganography techniques.

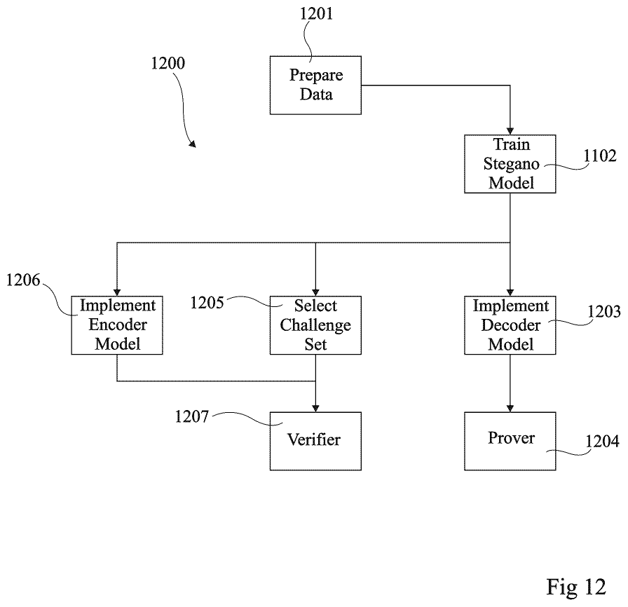

According to a variant, in connection with the method described in relation with FIG. 12, at step 901, device V selects data item Chall900, and generates the corresponding random secret data item Chal900Rsp. For this purpose, device V uses an encoder-type neural network, as described hereafter, to implant the secret into it.

At a step 902 (Receive Challenge), successive to step 901, prover device P receives data item Chall900 and may begin to implement the authentication method for its part.

At a step 903 (Cnt Challenge), device P may verify whether data item Chall900 has already been sent too many times, by using a counter. This step is similar to the step 403 described in relation with FIG. 4. When the counter value reaches a limiting value, a next step is a step 904 (Fail) where device P considers that method 900 has failed. If the counter value does not exceed the limiting value, the next step is a step 905 (Neural Networks Stegano).

At step 905, successive to step 903, prover device P uses a neural network to provide, or to generate, a response data item Rsp900 from data item Chall900. The neural network here works to find the data item hidden in data item Chall900, and provides a response data item Rsp900 corresponding to this hidden data item. Thus, response data item Rsp900 is a binary data item having number of values only limited by its format.

At an optional step 906 (Hash), device P may encrypt response data item Rsp900, for example by using an encryption algorithm, a signature algorithm, a hash algorithm, etc.

At step 907 (Send Response), device P sends response data item Rsp900 to device V, or, if applicable, the encrypted version of response data item Rsp900.

At a step 908 (Timer) implemented at the end of step 901, device V verifies the response time of device P by using a timer. Step 908 is similar to the step 407 described in relation with FIG. 4. When the value of the timer reaches a limiting value, a next step is a step 909 (Fail) where device V considers that method 900 has failed. If device V receives data item Rsp900 before the timer reaches the limiting value, the next step is a step 910 (Receive Response).

At step 910, successive to step 904, verifier device V receives the response data item from prover device P. If data item Rsp900 has been encrypted, a decryption step may here be implemented.

At a step 911 (Verify), verifier device V uses response data item Rsp900 to conclude as to the authentication, or not, of prover device P. For this purpose, device V may, for example, compare response data item Rsp900 with response data item Chall900Rsp. According to another example, at this step, device V implements a verification function taking as inputs data item Rsp900, and data item Chall900 or Chall900Rsp.

An advantage of this embodiment is that it enables to further increase the uncertainty of the response data item delivered by prover device P with respect to the challenge. This thus makes authentication method 900 more difficult to circumvent.

FIG. 10 is a block diagram illustrating the implementation of a steganography technique 1000 using neural networks.

Technique 1000 uses three neural networks, including:
a neural network 1001 (E) acting as an encoder, referred to as encoder 1001 hereafter;
a neural network 1002 (D) acting as a decoder, referred to as decoder 1002 hereafter; and
a neural network 1002 (D) acting as a determiner, referred to as determiner 1002 hereafter.

Encoder 1001 is adapted to receiving two data items, including a secret data item Sec 1000 and a data item Im1000 in which the secret data item is hidden. In some embodiments, data item Im1000 is an image comprising a plurality of pixels arranged in the form of an array. In some embodiments, data item Im1000 is a natural image, that is, an image that has undergone no preprocessing. Examples of data capable of being used are provided in the article “Zhang, Kevin Alex and Cuesta-Infante, Alfredo and Veeramachaneni, Kalyan, “SteganoGAN: High Capacity Image Steganography with GANs,” MIT EECS, January 2019”, and in the article “Varsha Kishore, Xiangyu Chen, Yan Wang, Boyi Li, Kilian Q Weinberger, “Fixed Neural Network Steganography: Train the images, not the network,” ICLR 2022 January 2022”. Encoder 1001 is trained to hide secret data item Sec1000 in data item Im1000 and to provide a new data item ImSec 1000 of same format as data item Im1000.

Decoder 1002 is adapted to receiving data item ImSec 1000 and to finding secret data item Sec 1000 therein.

Determiner 1003 is adapted to determining whether secret data item Sec1000 is efficiently hidden in data item ImSec1000. For this purpose, determiner 1003 tries to find secret data item Sec1000 in data item ImSec1000 and defines a score to evaluate the work of the encoder. This score may be used in a phase of training of encoder 1001.

FIG. 11 is a block diagram illustrating an implementation mode of a method 1100 of preparing the authentication method 900 described in relation with FIG. 9. This preparation method 1100 is a first example of a possible preparation method, a second example is described in relation with FIG. 12.

Generally, method 1100 comprises a method of training the neural network used by device P, and a method of generating a data group from which data item Chall900 is selected. Method 1100 further comprises the preparation of devices V and P.

At an initial step 1101 (Prepare Data), a group of data adapted to be used as training data for the neural network of device P is generated. In some embodiments, this data group may be an already-existing data group or a data group generated for authentication method 900. This data group thus comprises data in which secret data may be hidden, but in which no secret data item has been hidden yet.

At a step 1102 (Train Stegano Model), successive to step 1101, a neural network of encoder type, of the type of the encoder 1001 of FIG. 10, and a neural network of decoder type, of the type of the decoder 1002 of FIG. 10, are trained by using the data of the data group selected at step 1101. More particularly, these neural networks used can be trained by using the technique described in relation with FIG. 10.

At a step 1103 (Implement Decoder Model), the decoder-type neural network has finished being trained, it can then be implanted in an electronic circuit or device.

At a step 1104 (Prover), prover device P is equipped with the circuit or device in which said neural network is implanted.

At a step 1105 (Generate Challenge Sets), a data group in which secret data are hidden is formed by using, for example, an encoder-type neural network trained at the same time as the decoder-type neural network equipping device P at step 1104. In some embodiments, the encoder-type neural network is then removed.

At a step 1106 (Pick Challenge Sets), data are selected to form a data set used to implement authentication method 900. According to an embodiment, the data set formed at step 1106 comprises fewer data, or in rare cases the same number of data, as the data group generated at step 1105.

At a step 1107 (Verify), the data set defined at step 1106 is loaded, stored, in device V so that it can use it to implement authentication method 900.

Thus, a method of training the neural network of the device P of FIG. 9 comprises the following steps:
training data are generated; and
neural networks of encoder and decoder type are trained using the training data by using, for example, the steganography technique 1000 described in relation with FIG. 10.

FIG. 12 is a block diagram illustrating an implementation mode of a method 1200 of preparing the authentication method 900 described in relation with FIG. 9. This preparation method 1200 is a second example of a possible preparation method.

Generally, method 1200 comprises a training method for the neural network used by device P, and a method of generating a data group from which data item Chall900 is selected. Method 1200 further comprises the preparation of devices V and P.

At an initial step 1201 (Prepare Data), a group of data adapted to being used as training data for the neural network of device P is generated. In some embodiments, this data group may be an already-existing data group or a data group generated with a view to authentication method 900. This data group thus comprises data in which secret data may be hidden, but in which no secret data item has been hidden yet.

At a step 1202 (Train Stegano Model), successive to step 1201, an encoder-type neural network, of the type of the encoder 1001 of FIG. 10, and a decoder-type neural network, of the type of the decoder 1002 of FIG. 10, are trained by using the data of the data group generated at step 1201. More particularly, these neural networks used may be trained by using the technique described in relation with FIG. 10.

At a step 1203 (Implement Decoder Model), the decoder-type neural network has finished been trained, it can then be implanted in an electronic circuit or device.

At step 1204 (Prover), prover device P is equipped with the circuit or device in which said decoder-type neural network is implanted.

At step 1205 (Select Challenge Set), a data group is selected in which it is possible to hide secret data, for example part of the group established at step 1201 or a new data group.

At a step 1206 (Implement Encoder Model), the encoder-type neural network has finished been trained, it can then be implanted in an electronic circuit or device.

At a step 1207 (Verify), verifier device V is equipped with the circuit or device in which said encoder-type neural network is implanted. Thus, at each starting of authentication method 900, verifier device P can generate a challenge data item by using a secret data item and the associated image of the data group generated at step 1205.

Thus, a method of training the encoder-type neural network of device V, and the decoder-type neural network of device P of FIG. 9 comprises the following steps:
training data are generated; and
neural networks of encoder and decoder type are trained by using the training data, by using, for example, the steganography technique 1000 described in relation with FIG. 10.

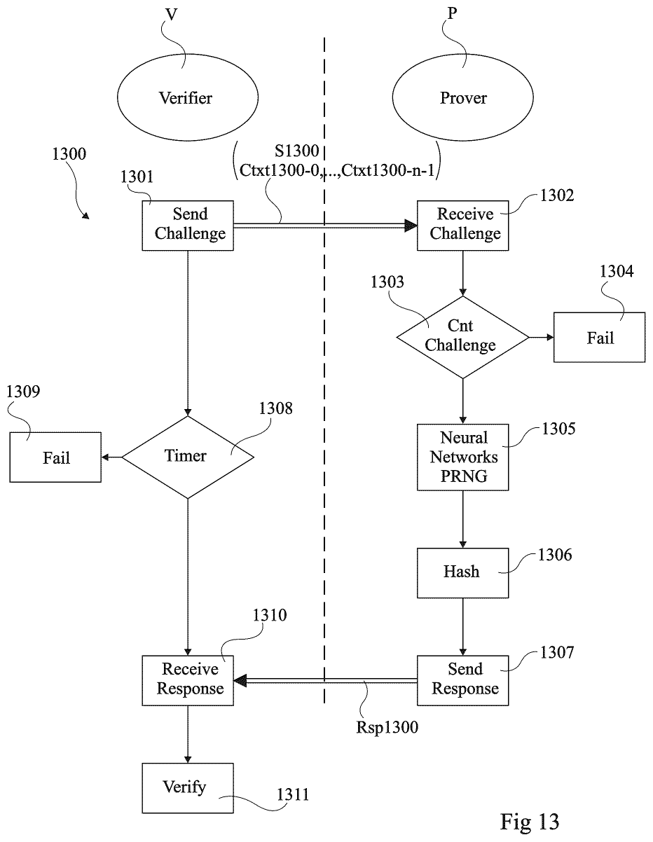

FIG. 13 is a block diagram illustrating a fourth example of an implementation mode of an authentication method 1300 enabling to authenticate prover device P to verifier device V, both defined in relation with FIG. 2.

Authentication method 1300 is a method of verifier/prover type of the type of the authentication method 200 described in relation with FIG. 2. The elements common to methods 200 and 1300 are not described again in detail herein. Only the differences between these methods are highlighted.

As previously mentioned, authentication method 200 uses a neural network, implemented by prover device P. In authentication method 1300, this neural network is adapted to generating a random or pseudo-random data item based on a seed data item and on one or a plurality of context data items.

At an initial step 1301 (Send Challenge), authentication method 1300 begins, for which verifier device V selects a “seed” data item S1300, or generation data item S1300, and one or a plurality of context data items Ctxt1300-0, . . . , Ctxt1300-n-1 to be sent to prover device P. In the example of FIG. 13, device V sends n context data items, n being a natural number.

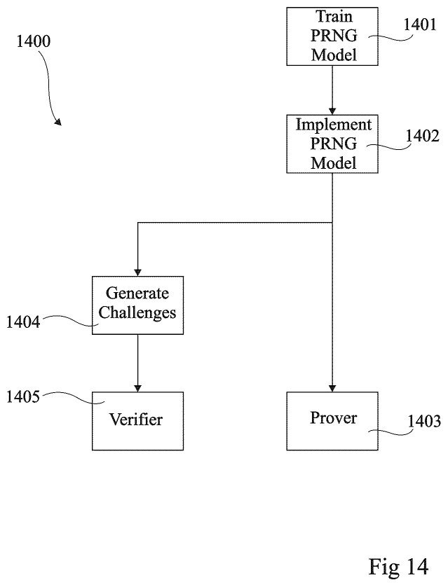

According to an embodiment, data S1300 and Ctxt1300-0, . . . , Ctxt1300-n-1 are selected from a finite group of data enabling to implement authentication method 1300. The data set from which data S1300 and Ctxt1300-0, . . . , Ctxt1300-n-1 are selected is defined in further detail in relation with FIG. 14. In the rest of the disclosure, there is called pair a data set comprising a “seed” data item and one or a plurality of context data items.

Further, each data pair S1300 and Ctxt1300-0, . . . , Ctxt1300-n-1 of the data group is associated a response data item Chall1300Rsp representing the random value that device P has to provide device V with to be authenticated.

At a step 1302 (Receive Challenge), successive to step 1301, prover device P receives data S1300 and Ctxt1300-0, . . . , Ctxt1300-n-1 and may begin to implement the authentication method for its part.

At a step 1303 (Cnt Challenge), device P may verify whether data pair S1300 and Ctxt1300-0, . . . , Ctxt1300-n-1 has already been sent too many times, by using a counter. This step is similar to the step 403 described in relation with FIG. 4. When the counter value reaches a limiting value, a next step is a step 1304 (Fail) where device P considers that method 1300 has failed. If the counter value does not exceed the limiting value, the next step is a step 1305 (Neural Networks PRNG).

At step 1305, successive to step 1303, prover device P uses a neural network to deliver, or to generate, a response data item Rsp1300 based on data S1300 and Ctxt1300-0, . . . , Ctxt1300-n-1. The neural network here works to generate a random number based on “seed” data item S1300 and context data Ctxt1300-0, . . . , Ctxt1300-n-1. Thus, response data item Rsp1300 is a binary data item having its number of values only limited by its format.

At an optional step 1306 (Hash), device P may encrypt response data item Rsp1300, for example by using an encryption algorithm, a signature algorithm, a hash algorithm, etc.

At a step 1307 (Send Response), device P sends response data item Rsp1300 to device V, or, if applicable, the encrypted version of response data item Rsp1300.

At a step 1308 (Timer) implemented after step 1301, device V verifies the response time of device P by using a timer. Step 1308 is similar to the step 407 described in relation with FIG. 4. When the timer value reaches a limiting value, a next step is a step 1309 (Fail) where device V considers that method 1300 has failed. If device V receives data item Rsp1300 before the timer reaches the limiting value, the next step is a step 1310 (Receive Response).

At step 1310, successive to step 1304, verifier device V receives the response data from prover device P. If data Rsp1300 has been encrypted, a decryption step may here be implemented.

At a step 1311 (Verify), verifier device V uses response data item Rsp1300 to conclude as to the authentication, or not, of prover device P. For this purpose, device V may, for example, compare response data item Rsp1300 with response data item Chall1300Rsp. According to another example, at this step, device V implements a verification function taking as inputs data item Rsp1300, and data item Chall1300 or Chall1300Rsp.

An advantage of this embodiment is that it enables to further increase the uncertainty of the response data item supplied by prover device P with respect to the challenge. This thus makes authentication method 1300 more difficult to circumvent.

FIG. 14 is a block diagram illustrating an implementation mode of a method 1400 of preparing the authentication method 1300 described in relation with FIG. 13.

Generally speaking, method 1400 comprises a method of training the neural network used by device P, and a method of generating a data group from which data S1300 and Ctxt1300-0, . . . , Ctxt1300-n-1 are selected. Method 1400 further comprises the preparation of devices V and P.

At an initial step 1401 (Train PRNG Model), a neural network of random or pseudo-random number generator type is trained. There exists a plurality of techniques enabling to train a neural network so that it generates a random number.

A first example of a technique consists in modeling the behavior of a neural network on that of a real random or pseudo-random number generator. For this purpose, such a generator is configured with context data and is supplied with a “seed” data item. This “seed” data item and these context data are also supplied to the neural network. The numbers generated by the generator and the neural network are compared by another neural network of discriminator type. The discriminator-type neural network adjusts the weights of the generator-type neural network so that its operation increasingly resembles that of the real generator.

A second example of a technique consists in the use of a neural network of random or pseudo-random number generator type and a neural network of predictor type. The generator-type neural network is improved until the predictor neural network is no longer capable of predicting the output data of the generator-type neural network.

Other examples of neural network training techniques for the generation of random or pseudo-random numbers are available to those skilled in the art. A non-limiting example of generating pseudo-random numbers using a neural network is provided in Marcello De Bernardi, M. H. R. Khouzani, Pasquale Malacaria. “Pseudo-Random Number Generation Using Generative Adversarial Networks” ECML PKDD 2018 Workshops, September 2018.

At a step 1402 (Implement PRNG Model), the neural network of random or pseudo-random number generator type has finished been trained, it can then be implanted in an electronic circuit or device.

At a step 1403 (Prover), prover device P is equipped with the circuit or device in which said neural network of the random or pseudo-random number generator type is implanted.

At a step 1404 (Generate Challenges), a group of data enabling to implement authentication method 1300 is formed. For this purpose, the neural network of random or pseudo-random number generator type trained at step 1402 is used. A plurality of pairs of “seed” data item and of context data are generated, and used to generate random or pseudo-random data with the neural network. These data pairs and the pseudo-random data that they enable to generate form the data group enabling to implement authentication method 1300. Once this group has been generated and step 1403 has been completed, the neural network of random or pseudo-random number generator type can be removed.

At a step 1405 (Verify), the data group generated at step 804 is loaded, stored, in device V so that it can be used to implement authentication method 1300.

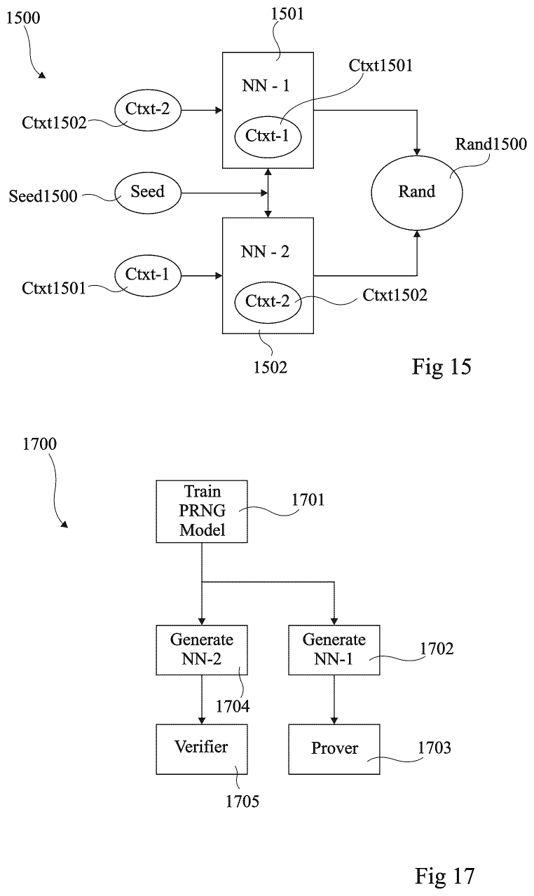

FIG. 15 is a block diagram illustrating an example of implementation of a random or pseudo-random number generation method 1500 using two neural networks 1501 (NN-1) and 1502 (NN-2).

As previously described, a neural network trained to generate random data generally receives as an input a “seed” data item and one or a plurality of context data items, preferably a plurality of context data items. In order to implement an authentication method, it is possible to “split” a neural network into a plurality of neural networks, for example two neural networks having, for example, at least one common part, enabling to generate a same random data item or a same sequence of random data items by taking the same “seed” data item and different context data items at its inputs.

More particularly, method 1500 uses two neural networks 1501 and 1502 originating from a same initial neural network (not shown in FIG. 15) adapted to generating a random data item. It is here considered that the initial neural network takes at its input a “seed” data item Sedd1500 and n context data items Ctxt1500-0, . . . , Ctxt1500-n-1, n being defined in relation with FIG. 13. The two neural networks 1501 and 1502 are obtained by directly integrating certain context data into the initial neural network. In some embodiments, the two neural networks 1501 and 1502 may have a common part, as will be explained hereafter.

More specifically, neural network 1501 is obtained by hard-writing a part Ctxt1501 (Ctxt-1) of context data Ctxt1500-0, . . . , Ctxt1500-n-1, for example p context data items Ctxt1500-0, . . . , Ctxt1500-p-1, p being an integer in the range from 0 to n-1. The expression “hard-coding” here means that the part Ctxt1501 of the context data is directly written into the code of neural network 1501. Similarly, neural network 1502 is obtained by hard-writing a part Ctxt1502 (Ctxt-2) of context data Ctxt1500-0, . . . , Ctxt1500-n-1, for example n-p context data items Ctxt1500-p, . . . , Ctxt1500-n-1. According to an embodiment, the union of parts Ctxt1501 and Ctxt1502 is equal to the n context data items Ctxt1500-0, . . . , Ctxt1500-n-1. In other words, parts Ctxt1501 and 1502 are said to be complementary, and neural networks 1501 and 1502 are said to be complementary.

Thus, to obtain a same random data item Rand1500 by using neural networks 1501 and 1502, it is sufficient to supply:
“seed” data item Seed1500 to each neural network 1501, 1502;
part Ctxt1502 to neural network 1501; and
part Ctxt1501 to neural network 1502.

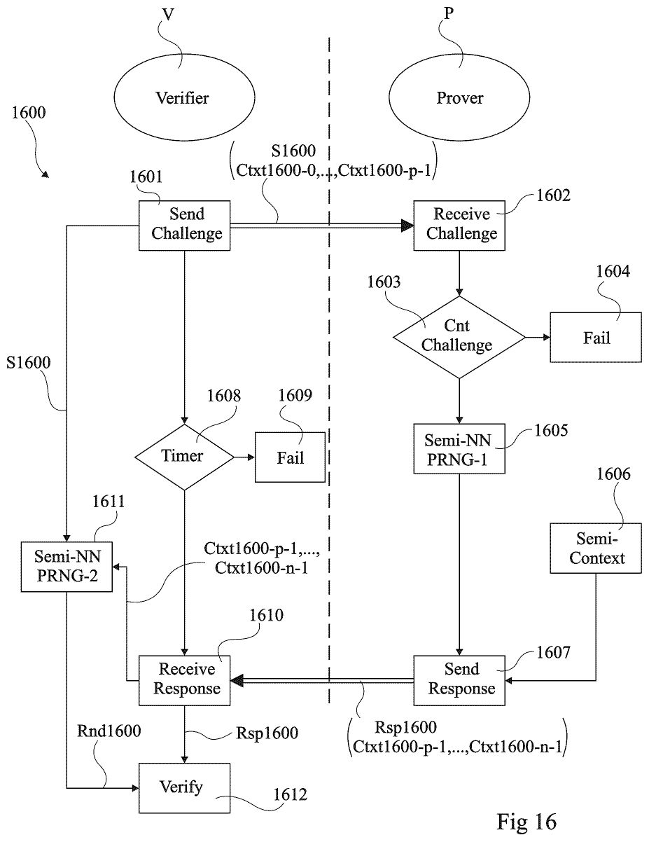

FIG. 16 is a block diagram illustrating a fourth example of an implementation mode of an authentication method 1600 enabling to authenticate prover device P to verifier device V, both defined in relation with FIG. 2.

Authentication method 1600 is a method of verifier/prover type of the type of the authentication method 200 described in relation with FIG. 2 and of the type of the authentication method 1300 described in relation with FIG. 13. The elements common to methods 200, 1300, and 1600 are not described again in detail herein. Only the differences between these methods are highlighted.

Authentication method 1600 uses two neural networks of the type of the neural networks 1501 and 1502 described in relation with FIG. 15.

At an initial step 1601 (Send Challenge), authentication method 1600 begins, for which verifier device V generates a “seed” data item S1600, or generation data item S1600, and a first group of context data Ctxt1600-0, . . . , Ctxt1600-p-1, of the type of the part Ctxt1501 or Ctxt1502 described in relation with FIG. 15, to send it to prover device P. In the example of FIG. 13, device V sends p context data, p being the integer defined in relation with FIG. 15.

At a step 1602 (Receive Challenge), successive to step 1601, prover device P receives data S1600 and Ctxt1600-0, . . . , Ctxt1600-p-1 and can begin to implement the authentication method for its part.

At a step 1603 (Cnt Challenge), device P may verify whether data pair S1600 and Ctxt1600-0, . . . , Ctxt1600-n-1 has not already been sent too many times thereto, by using a counter. This step is similar to the step 403 described in relation with FIG. 4. When the counter value reaches a limiting value, a next step is a step 1604 (Fail) where device P considers that method 1600 has failed. If the counter value does not exceed the limiting value, the next step is a step 1605 (Semi-NN PRNG-1).

At step 1605, successive to step 1603, prover device P uses a neural network of the type of the neural network 1501 or 1502 described in relation with FIG. 15, to provide, or to generate, a response data item Rsp1600 based on data S1600 and Ctxt1600-0, . . . , Ctxt1600-p-1. The neural network works to generate a random number based on “seed” data item S1600 and on context data Ctxt1600-0, . . . , Ctxt1600-p-1. Thus, response data Rsp1600 is a binary data item having a number of values only limited by its format.

More particularly, if device P implements a neural network of the type of the neural network 1501 described in relation with FIG. 15, the group of context data sent by device V is the part Ctxt1502 described in relation with FIG. 15. Conversely, if device P implements a neural network of the type of the neural network 1502 described in relation with FIG. 15, the group of context data sent by device V is the part Ctxt1501 described in relation with FIG. 15.

At a step 1606 (Semi-Context), device P prepares a group of context data complementary to the group of context data that it has received from device V. In some embodiments, if device P receives a data group of the type of part Ctxt1502, it prepares a data group of the type of part Ctxt1501. Conversely, if device P receives a data group of the type of part Ctxt1501, it prepares a data group of the type of part Ctxt1502. The preparation of this data group comprises, for example, the extraction of this data group from a memory of device P. In some embodiments, this data group may be “hard-written,” that is, encoded, in the neural network of device P.

Method 1600 could comprise a step of encryption of response data item Rsp1600 and of the group of context data comprising, for example, data Ctxt1600-p-1, . . . , Ctxt1600-n-1, for example by using an encryption algorithm, a signature algorithm, a hash algorithm, etc.

At a step 1607 (Send Response), device P sends response data item Rsp1600 and the group of context data comprising, for example, data Ctxt1600-p-1, . . . , Ctxt1600-n-1, to device V, or, if applicable, the encrypted version of these data.

At a step 1608 (Timer) implemented after step 1601, device V verifies the response time of device P by using a timer. Step 1608 is similar to the step 407 described in relation with FIG. 4. When the timer value reaches a limiting value, a next step is a step 1609 (Fail) where device V considers that method 1600 has failed. If device V receives data item Rsp1600 and the group of context data before the timer reaches the limiting value, the next step is a step 1610 (Receive Response).

At step 1610, successive to step 1604, verifier V receives response data item Rsp1600 and the group of context data from prover device P. If these data have been encrypted, a decryption step may here be implemented.

At a step 1611 (Semi-NN PRNG-2), the verifier device implements a neural network of the type of neural network 1502, if device P implements a neural network of the type of neural network 1501, by using the “seed” data item Seed1600 and the group of context data, for example context data Ctxt1600-p-1, . . . , Ctxt1600-n-1, sent by device P. This enables device V to generate a random data item Rnd1600.

At a step 1611 (Verify), verifier device V uses response data item Rsp1600 and random data item Rnd1600 to conclude as to the authentication or not of prover device P. For this purpose, device V may, for example, compare response data item Rsp1600 with data item Rnd1600. According to another example, at this step, device V implements a verification function taking as inputs response data item Rsp1600 and data item Rnd1600.

An advantage of this approach is that it enables to even further increase the uncertainty of the response data item supplied by prover device P with respect to the challenge. This thus makes authentication method 1600 more difficult to circumvent.

Another advantage is that this embodiment enables to diversify the neural networks implemented in devices P and V. It is thus possible to have a plurality of different devices P and V with different neural networks. This diversification makes the extraction of the network parameters more difficult for an attacker.

Another advantage is that it enables not to store result data in device V.

FIG. 17 is a block diagram illustrating an implementation mode of a method 1700 of preparing the authentication method 1600 described in relation with FIG. 16.

Generally, method 1700 comprises a method of training the neural networks used by devices P and V, and a method of generating a data group from which data S1600 and Ctxt1600-0, . . . , Ctxt1600-n-1 are selected. Method 1700 further comprises the preparation of devices V and P.

At an initial step 1701 (Train PRNG Model), a neural network of random or pseudo-random number generator type is trained, for example, by using the techniques described in relation with FIG. 14.

At a step 1702 (Generate NN-1), a neural network NN-1 of the type of the neural network 1501 or 1502 described in relation with FIG. 15 is generated based on the neural network trained at step 1701. This neural network can then be implanted in an electronic circuit or device.

At a step 1703 (Prover), prover device P is equipped with the circuit or device in which said neural network NN-1 is implanted, and also with means for storing, for example a memory or by direct encoding in neural network NN-1, part of the context data.

At a step 1704 (Generate NN-2), a neural network NN-2 of the type of the neural network 1502 or 1501 described in relation with FIG. 15 is generated based on the neural network trained at step 1701. This neural network may then be implanted in an electronic circuit or device. According to an embodiment, neural network NN-2 is complementary to the neural network NN-1 generated at step 1702.

At a step 1705 (Verify), verifier device V is equipped with the circuit or device in which said neural network NN-2 is implanted, and also with means for storing, for example a memory or by direct encoding in neural network NN-2, part of the context data different from the part of the context data stored in prover device P.

Various embodiments and variants have been described. Those skilled in the art will understand that certain features of these various embodiments and variants could be combined, and other variants will become apparent to those skilled in the art.

Finally, the practical implementation of the described embodiments and variants is within the abilities of those skilled in the art, based on the functional indications given hereabove.

A Method of authenticating (200; 400; 700; 900; 1300; 1600) a first device (P) to a second device (V), is summarized as including the following successive steps: sending, by said second device (V), to said first device (P), of at least one first data item (Chall200; Chall400; Chall700; Chall900; Seed1300, Ctxt1300-0, . . . , Ctxt1300-n-1; Seed1600, Ctxt1300-0, . . . , Ctxt1600-p-1); using, by said first device (P), of a first neural network to supply a second data item (Rsp200; Rsp400; Rsp700; Rsp900; Rsp1300; Rsp1600) based on said at least one first data item (Chall200; Chall400; Chall700; Chall900; Seed1300, Ctxt1300-0, . . . , Ctxt1300-n-1; Seed1600, Ctxt1300-0, . . . , Ctxt1600-p-1); and sending, by said first device, of said second data item (Rsp200; Rsp400; Rsp700; Rsp900; Rsp1300; Rsp1600) to said second device (V).

An electronic device being adapted to being the first electronic device (P) in the method of authenticating (200; 400; 700; 900; 1300; 1600) the first device (P) to a second device (V), is summarized as including the following successive steps: sending, by said second device (V), to said first device (P), of at least one first data item (Chall200; Chall400; Chall700; Chall900; Seed1300, Ctxt1300-0, . . . , Ctxt1300-n-1; Seed1600, Ctxt1300-0, . . . , Ctxt1600-p-1); using, by said first device (P), of a first neural network to supply a second data item (Rsp200; Rsp400; Rsp700; Rsp900; Rsp1300; Rsp1600) based on said at least one first data item (Chall200; Chall400; Chall700; Chall900; Seed1300, Ctxt1300-0, . . . , Ctxt1300-n-1; Seed1600, Ctxt1300-0, . . . , Ctxt1600-p-1); and sending, by said first device, of said second data item (Rsp200; Rsp400; Rsp700; Rsp900; Rsp1300; Rsp1600) to said second device (V).

an electronic device being adapted to being the second electronic device (V) in the method of authenticating (200; 400; 700; 900; 1300; 1600) a first device (P) to the second device (V), is summarized as including the following successive steps: sending, by said second device (V), to said first device (P), of at least one first data item (Chall200; Chall400; Chall700; Chall900; Seed1300, Ctxt1300-0, . . . , Ctxt1300-n-1; Seed1600, Ctxt1300-0, . . . , Ctxt1600-p-1); using, by said first device (P), of a first neural network to deliver a second data item (Rsp200; Rsp400; Rsp700; Rsp900; Rsp1300; Rsp1600) based on said at least one first data item (Chall200; Chall400; Chall700; Chall900; Seed1300, Ctxt1300-0, . . . , Ctxt1300-n-1; Seed1600, Ctxt1300-0, . . . , Ctxt1600-p-1); and sending, by said first device, of said second data item (Rsp200; Rsp400; Rsp700; Rsp900; Rsp1300; Rsp1600) to said second device (V).

Said first neural network is adapted to recognizing the presence of a feature in said at least one first data item (Chall400), and said second data item (Rsp400) is a binary data item indicating whether said feature is recognized or not.

Said at least one first data item (Chall400) is selected by a first group including third data preprocessed (Emb600) by said first neural network.

Said at least one first data item (Chall400) is selected by a second group including fourth data preprocessed (Emb600) by said first neural network, said second group satisfying the following mathematical formula:

$$dist ( V 0 , {V}^{′} 0 ) ≅ dist ( V 1 , {V}^{′} 1 ) ≅ dist ( V 0 , V 1 ) \qquad Math 3$$

where:

V0 and V′0 are preprocessed data leading to the first value of the output data item;
V1 and V′1 are preprocessed data leading to the second value of the output data item;
dist is a function enabling to calculate a distance in a multi-dimensional space including data V0, V′0, V1, and V′1; and
≅ is a symbol representing a relative equality of the type “in the order of”.

Said first neural network is adapted to classifying said at least one first data item (Chall700) according to at least three categories, and said second data item (Rsp700) indicating which category said at least one first data item (Chall700) belongs to.

Said second data item (Rsp900) has been hidden in said at least one first data item (Chall900), and said first neural network is adapted to extracting the second data item (Rsp900) from said at least one first data item (Chall900).

Said second data item (Rsp900) has been hidden in said at least one first data item (Chall900) by using at least a steganography technique implemented by a second neural network.

Said first neural network is adapted to randomly generating said second data item (Rsp1300; Rsp1600) based on at least two first data items including a fifth generation data item (Seed1300; Seed1600) and at least one sixth context data item (Ctxt1300-0, . . . , Ctxt1300-n-1; Ctxt1300-0, . . . , Ctxt1300-p-1).

Said first device (P) sends, in addition to said second data item (Rsp1600), at least one seventh context data item (Ctxt1600-p-1, . . . , Ctxt1600-n-1) different from the sixth context data item (Ctxt1600-0, . . . , Ctxt1600-p-1), said second device (V) being adapted to randomly generating an eighth data item (Rnd1600) by using said fifth generation data item (Seed1600) and said at least one seventh context data item (Ctxt1600-p-1, . . . , Ctxt1600-n-1), and said second device (V) using the second data item (Rsp1600) and the eighth data item (Rnd1600) to verify whether the first device (P) is authenticated or not the second device (V).

The method further includes a step of verification (206; 410; 711; 911; 1311; 1612) of said second data item (Rsp200; Rsp400; Rsp700; Rsp900; Rsp1300; Rsp1600) by said second device (V) to indicate whether the first device (P) is authenticated or not to the second device (V).

The method further includes a step of verifying (403; 703; 903; 1303; 1603) the number of times a specific first data item (Chall200; Chall400; Chall700; Chall900; Seed1300, Ctxt1300-0, . . . , Ctxt1300-n-1; Seed1600, Ctxt1300-0, . . . , Ctxt1600-p-1) is supplied to the first device (P).

The method further includes a step of verification (407; 708; 908; 1308; 1608) of the response time of the first device (P), implemented by said second device (V).

The method further includes a step of encryption (706; 906; 1306) of the second data item (Rsp200; Rsp400; Rsp700; Rsp900; Rsp1300; Rsp1600) before its sending to the second device (V).

Method of training a neural network of a first device (P) for the implementation of an authentication method.

System is summarized as including a first device and a second device.

Computer program product is summarized as including program code instructions for the execution of the steps of the method (200; 400; 700; 900; 1300; 1600) as being said first device (P), when said program is run on a computer.

Computer program product is summarized as including program code instructions for the execution of the steps of the method (200; 400; 700; 900; 1300; 1600) as being said second device (V), when said program is run on a computer.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of authenticating a first device to a second device, comprising the following successive steps:
sending, by said second device, to said first device, at least one first data item;
using, by said first device, a first neural network to supply a second data item based on said at least one first data item; and
sending, by said first device, said second data item to said second device.

2. The method according to claim 1, wherein said first neural network is configured to recognizing the presence of a feature in said at least one first data item, and said second data item is a binary data item indicating whether said feature is recognized or not.

3. The method according to claim 1, wherein said at least one first data item is selected from a first group including third data preprocessed by said first neural network.

4. The method according to claim 1, wherein said at least one first data item is selected from a second group including fourth data preprocessed by said first neural network, said second group satisfying the following mathematical formula:
$$dist ( V 0 , {V}^{′} 0 ) ≅ dist ( V 1 , {V}^{′} 1 ) ≅ dist ( V 0 , V 1 )$$
where:
V0 and V′0 are preprocessed data leading to the first value of the output data item;
V1 and V′1 are preprocessed data leading to the second value of the output data item;
dist is a function to calculate a distance in a multi-dimensional space comprising data V0, V′0, V1, and V′1; and
≅ is a symbol representing a relative equality of the type “in the order of”.

5. The method according to claim 1, further comprising:
classifying, using said first neural network, said at least one first data item according to at least three categories, wherein said second data item indicates which category said at least one first data item belongs to.

6. The method according to claim 1, wherein said second data item has been hidden in said at least one first data item, further comprising:
extracting, using said first neural network, the second data item from said at least one first data item.

7. The method according to claim 1, further comprising:
hiding, by said first device using a second neural network, said second data item in said at least one first data item by using at least a steganography technique.

8. The method according to claim 1, further comprising:
randomly generating, by said second device, said second data item based on at least two first data items comprising a fifth generation data item and at least one sixth context data item.

9. The method according to claim 8, further comprising:
sending, by said first device in addition to said second data item, at least one seventh context data item different from the sixth context data item;
randomly generating, using said second device, an eighth data item based on said fifth generation data item and said at least one seventh context data item; and
using, by said second device, the second data item and the eighth data item to verify whether the first device is authenticated to the second device.

10. The method according to claim 1, wherein the method further comprises:
verifying, by said second device, said second data item to indicate whether the first device is authenticated to the second device.

11. The method according to claim 1, wherein the method further comprises:
verifying, by said first device, a number of times a specific first data item is supplied to the first device.

12. The method according to claim 1, further comprising:
verifying a response time of the first device by said second device.

13. The method according to claim 1, further comprising:
encrypting, by said first device, said second data item before sending said second data item to the second device.

14. The method of claim 1, further comprising:
training the first neural network by the first device.

15. A system comprising:
one or more processors; and
one or more memories storing instructions executable by the one or more processors to:
obtain at least one first data item from a second device;
use a first neural network to supply a second data item based on the at least one first data item; and
authenticate to the second device based on the second date item.

16. The system of claim 15, wherein the one or more processors are further configured to:
classify, using the first neural network, the at least one first data item according to at least three categories, wherein the second data item indicates which category the at least one first data item belongs to.

17. The system of claim 15, wherein the one or more processors are further configured to:
extract, using the first neural network, the second data item from the at least one first data item, wherein the second data item has been hidden in the at least one first data item using steganography.

18. One or more non-transitory computer-readable media storing instructions executable by one or more processors to perform actions, the actions comprising:
sending, to a first device, at least one data item;
receiving, from the first device, a second data item produced using a first neural network based on the at least one data item; and
authenticating the first device based on the second data item.

19. The one or more non-transitory computer-readable media of claim 18, the actions further comprising:
hiding the second item in the at least one data item using at least a steganography technique.

20. The one or more non-transitory computer-readable media of claim 18, the actions further comprising:
classifying, using the first neural network, the at least one data item according to at least three categories, wherein the second data item indicates which category the at least one first data item belongs to.
